(19) United States
(12) Patent Application Publication
(10) Pub. No.: US 2005/0182793 A1
(43) Pub. Date: Aug. 18, 2005

(54) Map structure and method for producing

(76) Inventors: Viktor M. Keenan, Phoenix, AZ (US); Mark D. Malone, Tucson, AZ (US)

Correspondence Address: Lawrence R. Oremland, P.C., Suite C-214, 5055 E. Broadway Boulevard, Tucson, AZ, 85711, US

(21) Appl. No.: 11/062,280

(22) Filed: Feb. 17, 2005

Related U.S. Application Data
(60) Provisional application No. 60/545,501, filed on Feb. 18, 2004.

(51) Int. Cl. G09B 29/00; G06F 7/00; G06F 17/00

(52) U.S. Cl. 707/104.1; 283/34

(57) ABSTRACT

A new and useful map structure, particularly for an activity within a special region having a geographic boundary, and a technique for creating a map structure are provided. The map and technique are particularly useful in providing a map for use by a hunter in a designated hunting region. The map structure comprises a substrate and map data produced on the substrate. The substrate is designed to withstand the conditions of the special region (e.g. an authorized hunting region), and of the type of handling it is likely to encounter in during the actively in the special region. The map data is also provided in a form that is likely to withstand the conditions of the special region, and is of a type that is particularly useful to the activity in the special region. Moreover, in producing the map structure, an electronic data file is created from which the map data can be produced on the substrate. The electronic data file is configured to produce map data that includes at a predetermined scale a boundary of a special geographic boundary of the special region in which a special outdoor activity, e.g. hunting, is authorized, and that map data includes information (e.g. water tank locations, GPS grid and coordinate information) that are particularly useful for the special outdoor activity.

### RELATED APPLICATION/CLAIM OF PRIORITY

This application is related to and claims priority from provisional application Ser. No. 60/545,501, Filed: Feb. 18, 2004, which provisional application is incorporated by reference herein.

### BACKGROUND AND SUMMARY

The present invention relates to a map structure that includes a geographic boundary of a specialized outdoor activity region, e.g. a hunting region, and to methods for producing such a map structure.

Hunting regions (sometimes also referred to as hunting zones, hunting units, game or wildlife management units), are government-maintained geographic regions within a state or territory, in which special outdoor activities (e.g. hunting activities) are authorized at certain times of the year. Hunters receive authorization to hunt in specified hunting regions, and can only hunt in those specified regions, at specified times of the year.

States across the U.S. have millions of square miles of land that are dedicated for outdoor activities like Hunting, Wildlife Preservation, etc. Typically, State governments carve up their lands into management areas referred to as wildlife management regions, or specifically for hunting purposes, “hunt regions”. In many States, hunters usually get selected to hunt in a predetermined region via a lottery-type drawing, or some other managed application and selection process. This selection process dictates which species they will be allowed to harvest and which hunting region they are allowed to hunt those species in. Knowing where these regions are located in relation to each other and in relation to nearby cities, towns, or other known points or areas of interest poses a challenge for the everyday hunter, with respect to accurate and usable maps. Often they must read a legal boundary description, written in text, which may or may not be accompanied by a very rudimentary map produced by the State that explains where exactly a particular wildlife region exists. Knowing the region's boundaries and attributes (terrain, landmarks, what cities or towns are nearby, etc.) is particularly important as there are monetary fines and penalties that could result if an animal is harvested outside the hunter's pre-selected region's boundary. Furthermore, the hunter must be aware of areas within their hunt regions that may be off limits due to private land ownership, the existence of government or military lands, National Forest property, or areas inside a town boundary, etc.

Knowing all of this, in the applicants' experience, when a hunter obtains a license for the specialized hunting region, the hunter may have to acquire as many maps that are available that will overlap or come close to showing the location of that hunting region. These maps will always be disparate in form and function and will be presented in various formats and published from various sources. The hunter must then attempt to interpolate the hunt unit's position based on the written description, with whatever maps he or she purchases. It is not uncommon for a hunter to buy a series of commercial paper maps, atlases, government maps, etc. all at different scales and with different presentation formats, such that they can start to piece together where their hunting region is located, and just as important, determine what kind of terrain and other physical attributes of that region they can expect. It is important to note that commercial maps and most of the popular government-created maps do not typically show a State's hunting region boundary(ies) in such a way that can be useful to a hunter.

In the applicants' experience, hunters want to know enough about their authorized hunting regions to enable them to effectively understand and efficiently navigate their authorized hunting regions. However, in the applicants' experience, hunting region information varies state by state, and maps are not generally available that uniquely express the specific boundaries of the hunting regions, and often do not provide other information that is particularly useful to hunters.

In addition, in the applicants' experience, if a hunter is provided with a map of his/her authorized hunting region, the hunter is likely to use the map in the outdoor conditions of the hunting region, and may handle the map in ways that can damage a map produced on relatively fragile material such as paper. For example, applicants believe a map structure for use by a hunter in a hunting region is likely to encounter water, wind, debris, and other outdoor conditions that can damage the map structure. Moreover, hunters are likely to fold, roll or even crumple the maps, or otherwise handle the maps in ways that could damage the maps.

The present invention provides a map structure which is particularly useful in an outdoor region (e.g. a wildlife management region) with a geographic boundary in which a specialized activity (e.g. hunting) is authorized, and methods for producing and using such a map structure. For example, according to the preferred embodiment, the topographical and/or land ownership data is clipped to match the boundary, so the boundary and topographical and/or land ownership data are readily recognizable when printed on the substrate. The ability to readily recognize the boundary of a hunting region, and topographical and/or land ownership data within the boundary are particularly useful features to a hunter who is authorized to hunt in the hunting region.

The map structure comprises a substrate and various map data produced on the substrate. The substrate is designed to withstand the outdoor conditions of the outdoor region and of the type of handling the substrate is likely to encounter by a user performing the specialized activity within the outdoor region. The map data depicts the geographic boundary of the outdoor region, and is also provided in a form that is likely to withstand the outdoor conditions of the outdoor region, and is configured in a way that is particularly useful to a user performing the activity within the outdoor region.

Moreover, in producing the map structure, a data file (preferably an electronic data file) is created from which the map data can be produced on the substrate. The electronic data file is configured to produce map data that includes at a predetermined scale a geographic boundary of a special region (e.g. a wildlife management region or unit) in which a special outdoor activity (e.g. hunting) is authorized.

Additionally, the electronic data file is preferably configured to produce at the predetermined scale, the locations of specific geographic points of interest, e.g. water tanks, within the special geographic boundary. When the special geographic boundary relates to a hunting region, the electronic data file is configured to produce the locations of specific points of interest to hunters in the hunting region.

Still further, the electronic data file is preferably configured to produce a Global Positioning System (GPS) grid, and the electronic data file is also configured to produce GPS coordinate data and associated with the GPS grid for the outdoor region with the geographic boundary, so that the GPS coordinate data can be directly input to a GPS receiver device. For example, a GPS receiver device may be a hand held device that is specially configured to receive and transmit GPS coordinate data, a laptop computer or other device that is configured to receive and transmit GPS coordinate data. In applicants' experience, geographic coordinates represented on printed maps, although implied, are not explicitly presented in a map such that they can be interfaced easily with a GPS receiver device, for navigation purposes.

In addition, features such as topographical data, land ownership data and/or access data, which are particularly useful to a hunter in a hunting region, can be selectively produced within the boundary (and in the case of access data outside the boundary as well).

Moreover, according to the invention, the configuration of the substrate for a particular geographic boundary (e.g. the geographic boundary for a hunting region) is predetermined by the unique geographic or spatial configuration of the boundary of the geographic boundary.

It should also be noted that the unique geographic problem described above that exists in the Western United States is solved by the present invention, because an entire hunting region is placed on one single sheet of material (preferably material that will withstand the conditions of the hunting region during hunting season). In many cases a large, hunting region means a hunter would have to buy a small handful of different maps, which are at different scales, use different presentation formats, paper types, sizes, etc. This is very inefficient and difficult for an average sportsman to comprehend how to use these disparate maps together. For example, a highway road atlas produced at a scale of 1:1,000,000 (one to one million) that comes in a book of 8½″×11″ sheets is quite different from a government-created Forest Map, for example, using a scale of 1:250,000 (one to two hundred and fifty thousand) and rolls out to a size of 24″×36″. This presents many problems simply in how one uses those maps together when the objective is to accurately determine the location of the region, the boundary of the region, and what specific land attributes of interest are inside the region.

The hunter or outdoor enthusiast might end up taping adjoining maps together, keeping various copies of different maps which presents a storage issue (many hunters claim to have so many maps for a single hunting region, it's rather cumbersome to manage them, let alone make use out of them in a consistent manner). The present invention brings an easy to use method for hunters to use only one (1) sheet of material (that is preferably placed on a rugged substrate suitable for the outdoors)—and thereby solves another problem for hunters—who may lose the benefits of other types of maps due to wear and tear.

The present invention's concept of effectively “clipping” the map data to the edges of the hunting unit's boundary is another appealing feature appreciated by the hunter. The boundary is very easy to recognize, virtually eliminating the guess work.

Moreover, he present invention purposely fixes the scale of the maps (e.g. at 1:100,000) so that consistency remains throughout the entire series of maps. This eliminates the inefficiencies associated with using disparate maps at disparate sizes, scales, etc.

Further features of the present invention will be apparent from the following detailed description and the accompanying drawings.

### BRIEF DESCRIPTION OF THE DRAWINGS AND EXHIBITS

FIG. 1a is a schematic, perspective illustration of a map structure produced according to the principles of the present invention;

FIG. 1b is a top plan view of a map structure produced according to the present invention, at a reduced scale, and showing an entire wildlife management unit in the State of Arizona (such a map structure is sometimes referred to herein as a scout map);

FIG. 1c is a fragmentary illustration of part of the scout map of FIG. 1b, also at a reduced scale, and showing aspects of certain of the data layers that are used to create the scout map;

FIG. 1d is a fragmentary illustration of a corner of the scout map of FIG. 1b, also at a reduced scale, and particularly showing GPS grid and GPS coordinate data on the scout map;

FIG. 2 is a schematic illustration of the data layers that are used to produce a map structure, according to a preferred embodiment of the method of the present invention; and

FIG. 3 is a schematic illustration of a map structure according to the invention, and a GPS receiver device with which the map structure can be used, according to the principles of the present invention.

Exhibit A is a map structure for an entire wildlife management unit in the State of Arizona, that is sometimes referred to herein as a scout map type, and which has been produced according to the principles of the present invention;

Exhibit B is a map structure for a map type that shows a section of a wildlife management unit of the State of Arizona, that is a subset of the entire wildlife management unit of Exhibit A;

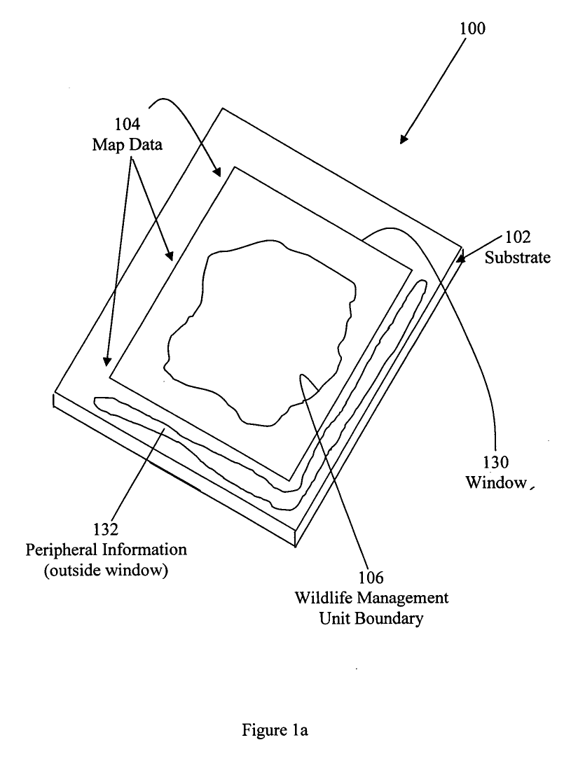

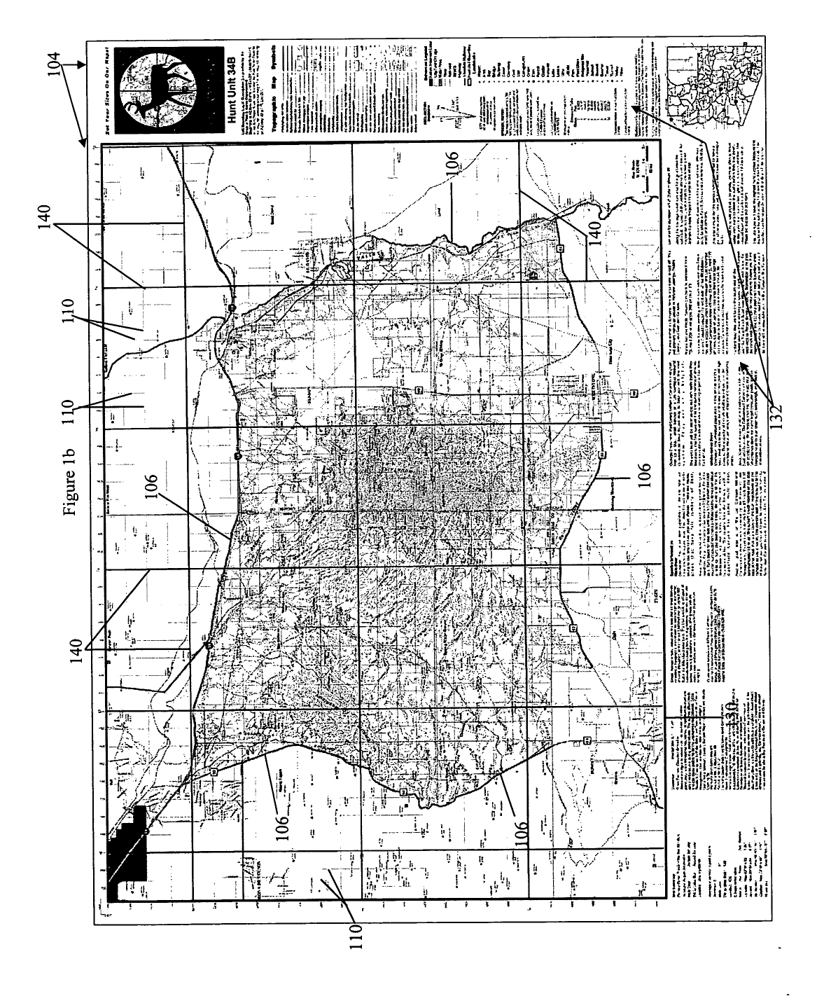

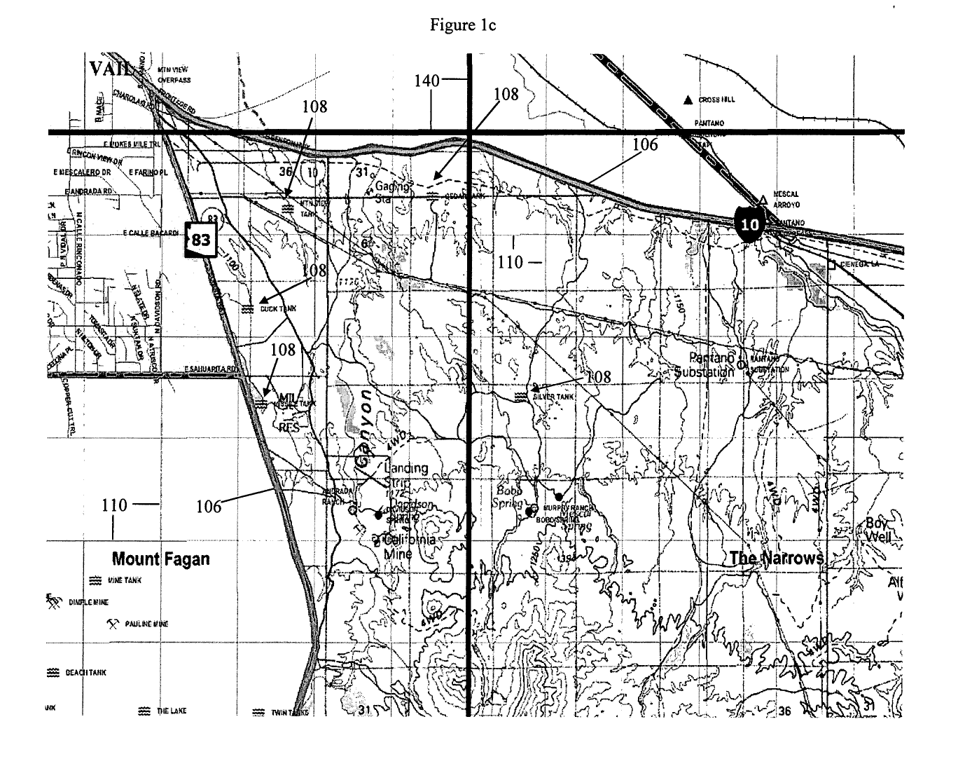

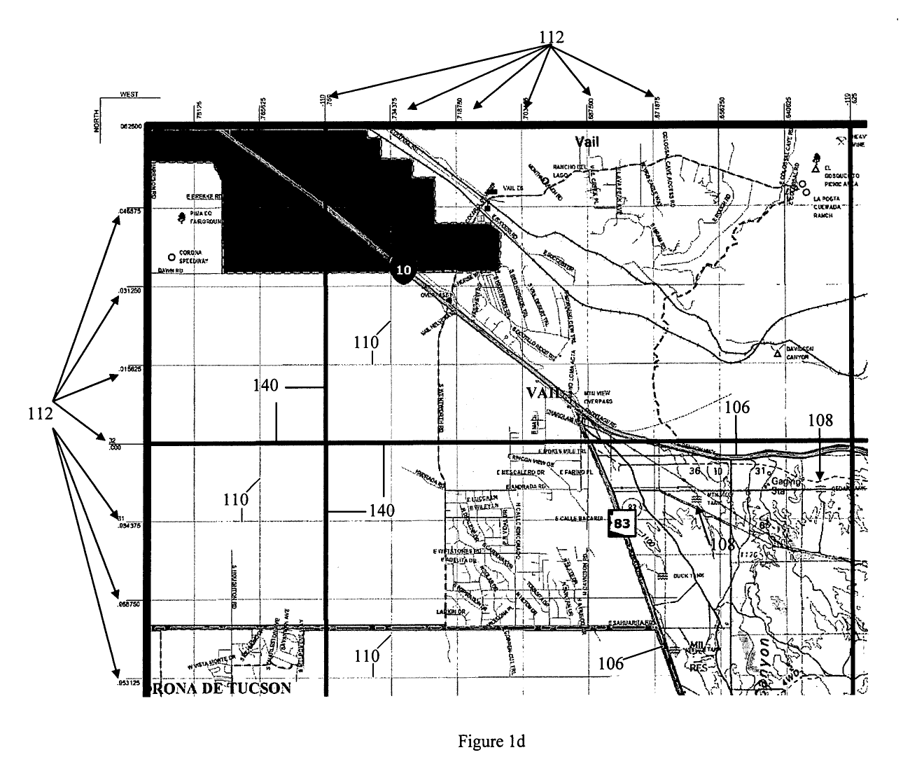

Exhibits C, D and E are color images of FIGS. 1b, 1c and 1e, respectively; and

Exhibit F is a map structure similar of the wildlife management unit of Exhibit A, but which is configured to highlight land ownership as a predominant feature.

### DETAILED DESCRIPTION

As described above, the present invention relates to a map structure, and to methods for producing the map structure, that is particularly useful as a map structure for a wildlife management unit such as a hunting region, that enables a hunter to effectively understand and efficiently function in an authorized hunting region. The principles of the invention are described below in connection with a map structure of a hunting region, and it will be apparent from that description how the principles of the invention can be used to produce and use a map structure for other types of specialized outdoor activity regions.

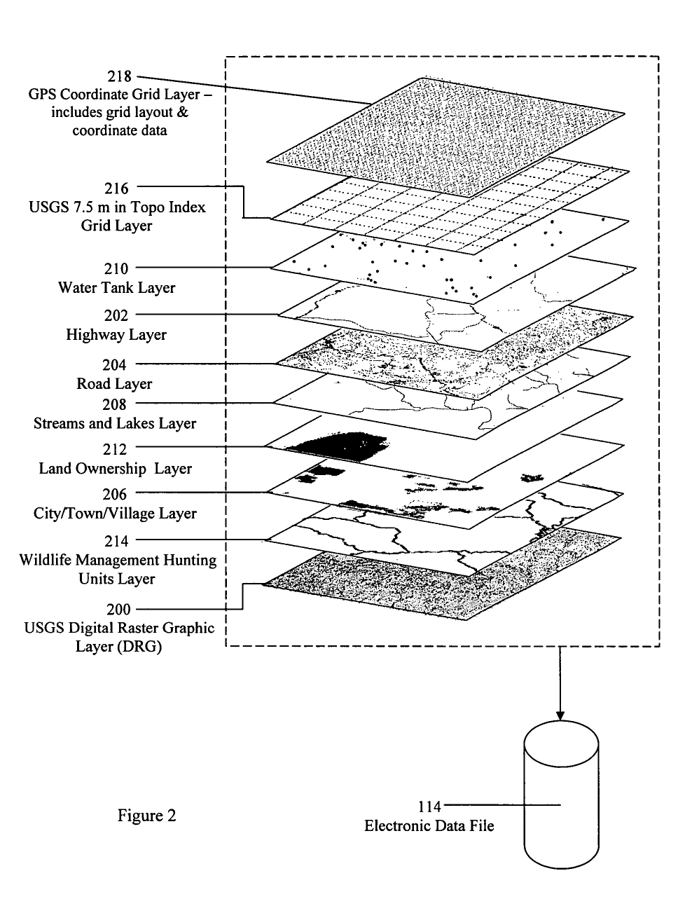

A map structure 100 according to the present invention comprises a substrate 102 and map data 104 produced on the substrate 102 (see FIG. 1a). The map data is produced from a data file 114 that is preferably created by the method illustrated in FIG. 2, as described more fully below.

The substrate 102 is a “single substrate” and the map data 104 is produced on the single substrate (see e.g. FIG. 1b and Exhibits A, F). In this application, the term “single substrate” means a single sheet of material, or a single section of material that the detachable from the remainder of the material, so that the single section of material forms a single sheet of material

The map structure 100 is designed for use by a hunter who is authorized to hunt in a designated hunting region that has a geographic boundary. Thus, the substrate 102 and the map data 104 are integrally related to each other, in accordance with the information that is provided to a hunter about the hunting region, including the geographic boundary of the hunting region, and the conditions under which the hunter is likely to need or want to use a map structure bearing that information. Specifically, the substrate 102 is configured to resist deterioration under the weather and handling conditions that it is likely to encounter in the hunting region, and the map data 104 is configured to provide the hunter with the type of information that is of most interest to a hunter looking for, or hunting within the hunting region. The map data 104 provides an image of the hunting region, and particularly the boundary 106 of the hunting region, including e.g. topographical information relating to the hunting region (see e.g. FIGS. 1b-d, Exhibits A-F) and places of particular interest to hunters that are located within that boundary (see, e.g. FIGS. 1b-d, Exhibits A-F). For example, in Western regions of the United States, water tanks 108 (FIGS. 1c, 1d, Exhibits D, E) are particularly useful to a hunter, since animals are most likely to seek out water tanks. Moreover, the map data 104 preferably includes a window 130 (FIGS. 1a, 1b, Exhibits A, C) within which the hunting region boundary 106 is provided, and peripheral information 132 (FIGS. 1a, 1b, Exhibits A, C) is provided outside the window.

The map data 104, including the uniquely defined boundary 106 and any specific hunt information, e.g., topographical information, land ownership information, access information, are produced based on that predetermined scale. Moreover, the configuration of the substrate is predetermined by the predetermined scale of the map and the configuration of the hunting region. Specifically, the configuration of the substrate 102 can be determined from the configuration and scale of the hunting region boundary 106. Moreover, the substrate 102 is formed of a material that is substantially resistant to physical deterioration under the normal weather conditions of the designated hunting region during hunting season and substantially resistant to deterioration under normal use by a hunter in the designated hunting region. The substrate 102 preferably comprises a vinyl, and even more preferably a scrim vinyl material. Vinyl material referred to as “scrim vinyl” is available from Hewlett Packard, but other comparable vinyl or other water resistant materials may also be suitable. Vinyl material, including scrim vinyl material, is generally resistant to the types of outdoor conditions that would typically encounter in a hunting region, and both types of material are also capable of being folded, rolled, or even crumpled, without losing their essential structural integrity.

Also, the map data 104 is applied to a surface of the substrate 102, in a manner designed to resist deterioration when subjected to the normal weather conditions of the designated hunting region during hunting season. The map data 104 is preferably applied to the surface of the scrim vinyl substrate 102 in an ink composition (e.g. pigment or dye based ink) that has been allowed to cure for a time (e.g. about 24 hours) that resists running when subjected to the normal weather conditions of the designated hunting region during hunting season.

A map structure according to the preferred embodiment also includes a GPS grid 110, (see e.g. FIGS. 1b, 1d, Exhibits A, C and E). The GPS grid 110 provides a visual latitude and longitude grid that enables a hunter to conveniently locate the GPS coordinate data 112 to key into a GPS receiver device 300 (FIG. 4). Moreover, the GPS coordinate data 112 is in a predetermined coordinate system, e.g. in decimal degrees, (FIG. 2, Exhibits A and B), to enable a hunter to key in the GPS coordinate data directly from the map to a GPS receiver device, in the same coordinate system. Thus, a hunter can locate a point of interest on the map structure, identify the GPS coordinates from the GPS grid 110, and also have the GPS coordinate data provided on the GPS grid in a predetermined coordinate system (e.g. in decimal degrees), so that the hunter can key the GPS coordinate data directly into a GPS receiver device, in the same coordinate system, without having to interpret or extrapolate anything in order to get that coordinate data. In addition, a hunter who uses a GPS receiver device to navigate a hunting region may receive GPS coordinate data in decimal degrees from the GPS receiver device 300, and use that received GPS coordinate data to navigate to a desired point of interest on the map structure.

As seen e.g. from FIGS. 1b and Exhibit A, in a map of a hunting region, the substrate preferably comprises a single substrate, and the map includes the boundary 106 of an entire predetermined hunting region. The boundary 106 is highlighted, in regard to other material on the map, so that a hunter can quickly and clearly understand the boundary of the hunting region. In addition, in one preferred type of map structure, the map includes topographical data for the hunting region within the boundary (see e.g. FIG. 1b, Exhibit A). Alternatively, the map structure may include land ownership data for the hunting region within the boundary, as shown in Exhibit F, since land ownership may in some instances be as important to a hunter as topographical information regarding the hunting region. The land ownership information may be provided in a companion map to a topographical map (see e.g. Exhibits A and F), or in may be included with the topographical data. Still further, as seen from Exhibit A, the map structure includes access data providing information about access to areas of the hunting region within the boundary (and preferably such access data also provides information about access from outside the boundary to the hunting region within the boundary). That access data is designed to enable a hunter to navigate the terrain within the hunting region, and also to navigate the terrain outside the hunting region, to reach a desired location within the hunting region.

As discussed above, according to the preferred embodiment, the topographical and/or land ownership data is clipped to match the boundary, so the boundary and topographical and/or land ownership data are readily recognizable when printed on the substrate. The ability to readily recognize the boundary of a hunting region, and topographical and/or land ownership data within the boundary are particularly useful features to a hunter who is authorized to hunt in the hunting region. The boundary is very easy to recognize, virtually eliminating the guess work. Moreover, as seen from Exhibits A and F, the boundary can be highlighted, to further simplify a hunter's ability to quickly and easily recognize his/her authorized hunting region.

The manner in which the map data is created can be appreciated from FIG. 2. In one preferred technique, a series of data layers, as labeled on FIG. 2, are created and overlaid, as illustrated in FIG. 2 and described further below. The data layers are used to create an electronic data file 114 that enable the map to be produced on a substrate configured in accordance with the scale of the map data. Thus, an electronic file 114 is created from which a special map structure with a special region that includes a geographic boundary can be produced, the special map structure comprising a substrate (e.g. of scrim vinyl material) and map data 104 of the special region and its geographic boundary (e.g. a hunting region) in which a special outdoor activity takes place.

Data is acquired from which the electronic file 114 is created, for producing the map data on the substrate. The acquired data includes data from which the electronic file can be configured to produce the special region with the geographic boundary 106 of the special region, at a predetermined scale. Such acquired data may be electronically acquired data, and some data may be acquired in printed format (or other formats in which it may be available), and used to produce the digitized data that is stored in the electronic data file 114. Such acquired data can be obtained from various public sources such as State or National organizations (e.g. State Fish and Game Departments, National organizations such as the Census Bureau, which produces TIGER map data, the US Geological Survey (USGS), the bureau of Land Management, US Department of Transportation, etc.). The acquired data may also be obtained from other commercially available map data sources. The particular source for acquired data may depend on the particular information that is desired to be provided in the map data, and the various ways such data can be acquired, to produce the map data for a map structure according to the present invention, will be readily apparent to those in the map-making art. Moreover, additional resources for acquiring data for a specific wildlife management unit may be gazetteer points, which are well known to those in the map making arts, and from persons (e.g. hunters) who have scouted a wildlife management region and know of specific points of particular interest to hunters. The acquired data may be in digital Geographic Information Systems (GIS) map-making format, which makes it easier to work with in producing the map data. The acquired data may also be in other formats and may be put into GIS format, or into other electronic formats that can be used, according to the principles of the present invention, to produce a map structure of a wildlife management region.

The acquired data also preferably comprises data from which the electronic file 114 can be configured to produce the locations of specific outdoor point of interest, e.g., water tanks 108 within the geographic boundary, at the predetermined scale. Still further, the acquired data includes data from which the electronic file can be configured to produce the GPS grid and GPS coordinate data (in decimal degrees, for example), at the predetermined scale. Moreover, the acquired data can include a lot of other information that is considered useful to a person in a particular wildlife management unit, and that acquired data can be used to produce the map data that is found within the boundary 106 of the wildlife management unit, as well as the information that is provided as peripheral information 132 outside the window 130 (FIGS. 1a, 1b, Exhibits A, C). Such data may include considerable text and graphical image data such as descriptions of points of interest, wildlife information (e.g. wildlife species found in the region), climate information for the region, land ownership information, or legends that enable a user (e.g. a hunter) to understand and navigate the terrain of the wildlife management region. Also, it should be noted that the present invention contemplates selecting certain layers from the available layers, to produce a map that highlights certain predominant features. For example, an additional layer (e.g. in addition to or in place of layer 200 in FIG. 2) can be provided to show land ownership regions within a wildlife management unit, e.g. 212. Those land ownership regions may have different colors, to help a map user readily distinguish between e.g. government lands, private lands, Native American reservations, etc. If it is desired to produce a map of a wildlife management unit that highlights a feature such as land ownership, the land ownership layer can be produced in place of, or in addition to, other layers to highlight land ownership. As an example, there are users of a wildlife management unit that may be predominantly interested in land ownership. Thus, a map structure can be provided that may use a land ownership layer in place, e.g. of the USGS Digital Raster Graphic Layer 200, to show land ownership as a predominant feature. Exhibit F is a map structure similar of the wildlife management unit of Exhibit A, but which is configured to highlight land ownership as a predominant feature.

Thus, the present invention provides a map structure and a technique for forming a map structure, e.g. for a wildlife management unit such as a hunting region, wherein an electronic data file 114 of digitized data is preferably configured to produce on a substrate map data that includes the boundary of a specific hunting region, the locations of specific points of interest for hunters, e.g., water tanks 108 within the hunting region, a GPS grid 110 at a predetermined scale that relates to the boundary scale and GPS coordinate data 112, in a predetermined coordinate system (e.g. in decimal degrees), associated with the GPS grid (see e.g. FIGS. 1d, Exhibit E and Exhibit A).

The configuration of the substrate 102 on which the map data is produced is determined by the conditions the map structure is likely to encounter, in use, in the special geographic region, e.g. the particular wildlife management unit, and also by the boundary configuration and scale of the region that is being produced.

A map of a hunting region is preferably created in the following manner (see FIG. 2):

A. Initially, it is preferred that two standard map types, at two different scales will be produced per hunting region (hunting region), as follows:

1. A first map type sometimes referred to as a scout map type, that depicts an entire hunting region at a predetermined scale (e.g. a 1:100,000scale). FIG. 1b and Exhibit C show a scout map for a wildlife management region of the State of Arizona, at a reduced scale. FIGS. 1c, 1d and Exhibits D and E show portions of the scout map, also at a reduced scale. Exhibit A is a scout map for a wildlife management region in the State of Arizona, at the predetermined scale.

2. A second map type that is a predetermined subset of the entire wild life management unit, that is scaled, e.g. at the standard 7.5 min USGS (United States Geological Survey) topographic, 1:24,000 scale map. The number of such second types of maps may vary in size, number, and scale depending on the number of subsets that are predetermined for a particular wild life management unit. Exhibit B is an example of the second type of map, for a section of the scout map type of Exhibit A. In FIGS. 1b, 1c, 1d, and Exhibits C, D and E, grid line 140 show the 7.5 min sections of a scout map that define the subsets that are the second map types.

B. As illustrated in FIG. 2, the map types will each preferably contain the following geographic base layer information, which is acquired from data from which the base layers can be produced, and which data can be scaled to the scale of a particular wild life management region:

1. USGS Digital Raster Graphics (DRG's) for the above mentioned map types (layer 200). This layer basically provides background for the wild life management region, or predetermined subset thereof. This layer also provides topographical land base data showing elevations, terrain, etc. Also, in producing the electronic data file 114, this layer is preferably clipped uniquely to the hunting region boundary 106, which helps hunters recognize and navigate the illustrated hunting region. This concept can be clearly seen in FIG. 1b, Exhibit C and Exhibit A.

2. Interstate and local highways data (layer 202) and Road layer data (layer 204). These layers provide a hunter with information that enables a hunter to find the most efficient route to drive to a location of interest. Such data layers may be obtained, e.g. from the US Department of Transportation, and in some cases in GIS map-making software format.

3. City/town/Village boundaries (layer 206). This layer provides a hunter with information that enables the hunter to avoid hunting activity within city/town/village boundaries where hunting may be prohibited. Such data may be acquired, e.g. from the US Census Bureau TIGER data.

4. Streams and Lakes data (layer 208) and water tank data (layer 210). Water tank data may include, e.g. (a) natural and artificially created water tanks (e.g. dams, drainage ditches) that may be of particular interest to animals in a wildlife management region, (b) so called “trick tanks” that are moved about in a wildlife management region as part of a wildlife maintenance resource, and (c) other water holding locations that may be of particular interest to animals in a wildlife management region. These layers provide a hunter with information as to water sources for animals within the hunting region, which in some areas is often of primary interest to a hunter. Stream and lake data can be acquired, e.g. from resources such as the Environmental Protection Agency (EPA). Water tank layer data can be acquired, e.g. from gazetteer points, which are well known resources in the map making arts, as well as from individual scout data from hunters who have scouted a particular wildlife management region.

5. Major Landmark Areas (layer 212): Specifically Federal and Indian Lands as well as the following points of interest:

(Military, education, shopping/retail, golf courses, cemetery, national parks/forest, state park/forest, etc.). Federal and Indian Land data can be acquired, e.g. from the Bureau of Land Management. Points of interest data can be acquired, e.g. from gazetteer data sources.

6. A wildlife management region boundary (layer 214), which is in digitized form. Such a wildlife management region is acquired and generated, e.g. for a hunting region for the state of Arizona, from registered GIF image(s) acquired from the Arizona Fish and Game Department's website. That layer is used to produce the boundary 106 of the wildlife management region, when the map data is produced on the substrate. There are various other sources for data from which a boundary for a wildlife management region can be acquired and the boundary generated, depending on the particular information available from the territory in which the wildlife management region is located. Some states may produce the data in GIS map-making software format; others may produce the data in forms that require the boundary data to be drawn and manipulated, to put it in a format (e.g. GIS format) that is useful in producing the electronic data file 114.

7. On the scouting map type, which would normally depict an entire wildlife management region, the USGS 7.5 min topographic quad index grid is provided (layer 216) with the name of each quad clearly but not obtrusively displayed. Hunters are very familiar with 7.5 min series quads, and find that information is particularly useful for cross referencing purposes (see e.g. Exhibits A, B).

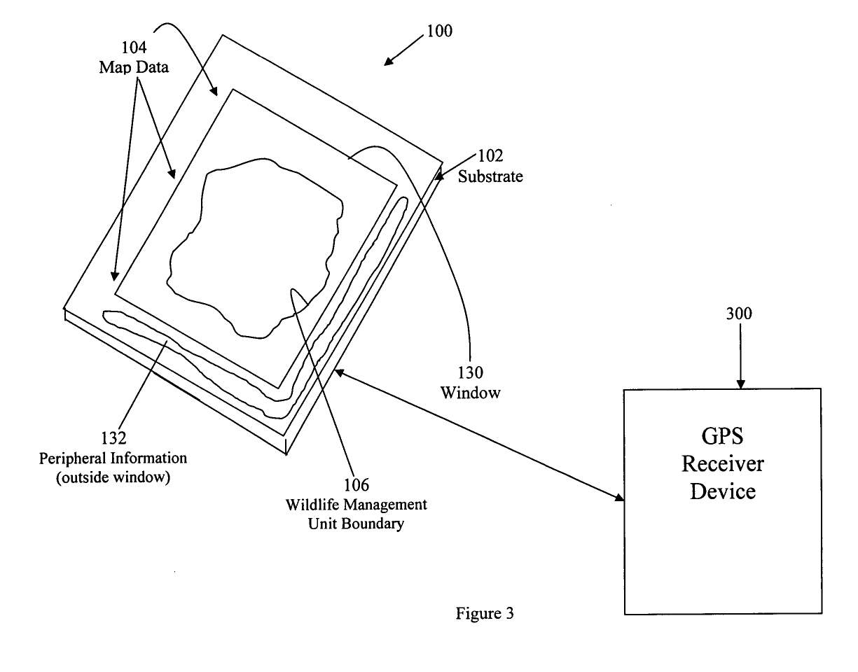

8. GPS coordinate grid layer (layer 218). As described above, this layer provides a hunter with a GPS grid, and associated GPS coordinates, to enable a hunter to efficiently locate GPS coordinates, and to key those coordinates directly into a GPS receiver device (e.g. GPS receiver device 300 in FIG. 3). The GPS coordinate grids will equally and evenly divide the standard 7.5 minute grid into 64 equal squares approximately 1 mile×1 mile. FIGS. 1b, 1c, 1d, Exhibits A, C, D, E and F show the 7.5 min grids (see e.g. grid lines 140) and the GPS grids 110, and FIG. 1d, Exhibits A, E and F show the GPS coordinate data. It is also contemplated that the GPS coordinate data may be provided in other coordinate systems (e.g. UTM meters, state plant feet, etc.) that enable that GPS coordinate data to be input directly to a GPS system, in the same coordinate system.

It is contemplated that data such as railroads may also be provided. Moreover, points of interest such as water tanks for a Wildlife Management Region, that are of particular interest to a hunter, may have specific graphical images that enables a hunter to quickly locate them (see e.g. water tank images 108 in FIGS. 1c, 1d, and Exhibits A, D and E). Similarly, other points of interest, such as airports, bridges, buildings, canals, cemetery, etc., that are provided in that layer, may also have graphical images to enable a hunter to rapidly identify them.

A hunting region map, according to the present invention, is produced in the following way: Initially, a base map template is created, preferably using Geographic Information Systems (GIS) map-making technology: Only the base map information using the layers described above (except for the GPS grid layer) are used to produce the base map template (no legends, titles, etc., these are added to the final template). The base map is then scaled and a basic layout is created by determining the substrate scale using the example described below:

[[Example of determining substrate scale for Arizona Hunting Unit 6A, at a map scale of 1:100,000: [NOTE: a scale of 1:100,000 says that 1 substrate unit (inches, feet, meters, etc.) is equal to 100,000 earth units (inches, feet, meters, etc. NOTE further that while Arizona Hunting Unit 6A is not shown in the figures or exhibits, its boundaries are known to hunters authorized to use that hunting region, an the following example is provided to show how the substrate scale for that hunting region is determined, as will be appreciated by those in the art)

The east/west real world distance=43.549 miles

The north/south real world distance=54.920 miles

Therefore, to produce a map at a fixed 1:100,000 scale the paper dimensions are computed using the following ratio:
Where: 1 mile=63,360 inches

Thus (to calculate the east/west (X) paper distance and maintain a useful scale of 1:100,000):
1 in/100,000 in=X in/(43.549 mi*63,360 in)
1 in/100,000 in=X in/2,759,264.64 in
X=2,759,264.64 in/100,000 in
X=27.592 inches

And (to calculate the north/south (Y) paper distance and maintain a useful scale of 1:100,000):
1 in/100,000 in=Y in/(54.920 mi*63,360 in)
1 in/100,000 in=Y in/3,479,731.2 in
Y=3,479,731.2 in/100,000 in
Y=34.797 inches

A map structure that will encompass Arizona Hunting Unit 6A at a scale of 1:100,000 would have to be 27.592 inches×34.797 inches, to illustrate the hunting region, and would be larger to accommodate the peripheral information 132 that is outside the window 130 in the layout for that hunting region.]]

The various layers described above, and shown in FIG. 2, are then scaled, as necessary, and overlaid, in the manner described and shown in FIG. 2. Some layer data may be clipped, to produce map data that will conform to the boundary 106 of the wildlife management region. Once the data is inserted into the dimensioned layout for the particular wildlife management unit, it can be printed as a set scaled document, e.g., Portable Document Format (PDF, Adobe Acrobat) at an ideal resolution (e.g., 600 dpi) directly from the GIS software.

The electronic document (e.g., PDF) is then saved as into an electronic image (e.g. PNG) using any publishing software (e.g., Adobe Acrobat). This image (e.g., PNG) is then inserted into the final map layout template, using publishing software (e.g., Corel Draw). Once within the publishing software's map template, all necessary titles, key maps, species info, and unit descriptions are edited to reflect the specific wildlife management region. The GPS grids and GPS coordinate data are edited manually.

The final specific map is then saved as a PDF file, and can be plotted onto scrim vinyl water resistant material, e.g. using a printer/plotter. The ink that is used to print/plot the map data is preferably a pigment or dye based ink, which is allowed to cure for a sufficient time (e.g. 24 hours) such that it should be able to withstand the outdoor conditions of a hunting region without running.

Such a map is particularly configured to be useful to a hunter. The map layout provides a hunter with an easy to read layout of a specific hunt region (scout map), or a specific subset of the scout map. As discussed above, topographical and/or land ownership data is clipped to match the boundary, so the boundary and topographical and/or land ownership data are readily recognizable to a hunter who is authorized to hunt in the hunting region. Significant points of interest, e.g. water tanks, are presented in images that are easy for a hunter to read and identify. Moreover, the GPS grid, and the associated GPS coordinates, in decimal degrees, enables a hunter to quickly and efficiently identify a location of interest, and key in the relevant information directly to a GPS device, to enable the hunter to quickly and efficiently get to a location of interest to that hunter.

In addition, the map is designed to withstand the normal conditions of the hunting region (e.g. water, wind, debris), and is also designed to withstand the normal ways it is likely to be handled by a hunter in the hunting region. Thus, it is designed to withstand being folded, rolled, or even crumpled, and still retain its essential integrity, so that a hunter can repeatedly use it.

Furthermore, while the principles of the present invention are preferably designed to produce map data on a water resistant material such as scrim vinyl material, in the event a hunting region map is intended for use in which it is not subject to the outdoor conditions of a hunting region (e.g. if the map were intended to be framed and mounted on a wall), the principles described above for creating the electronic file (i.e. the PDF file) can still be used, but the map data can then be produced on a substrate suitable for framing, rather than the water resistant substrate that is preferred for a map structure for outdoor use.

Accordingly, applicants have provided a map structure, and related map-making techniques, which are particularly well suited for producing hunting region maps. Moreover, it will be clear to those in the art that similar structures and techniques can be used to produce maps for other types of outdoor activities (e.g. hiking, cycling) that are likely to take place within designated outdoor area within a geographic boundary, and wherein the ability of the map structure to convey useful information while resisting the environmental conditions of the outdoor area, and also resisting normally handling by a participant in the outdoor activity.

With the foregoing disclosure in mind, the manner in which the principles of the present invention can be used to produce various types of map structures will be apparent to those in the art.

1. A map structure designed for use by a hunter who is authorized to hunt in a predetermined hunting region that is an outdoor region with a geographic boundary, the map structure comprising a substrate having a map of the outdoor region, including the boundary of the outdoor region, at a predetermined scale that is related to the configuration of the substrate, and the substrate comprising a material that is substantially resistant to physical deterioration under the normal weather conditions of the predetermined hunting region during hunting season and substantially resistant to deterioration under normal use by a hunter in the predetermined hunting region.

2. A map structure as defined in claim 1, wherein the map comprises map data applied to a surface of the substrate, in a medium that resists deterioration when subjected to the normal weather conditions of the predetermined hunting region during hunting season.

3. A map structure as defined in claim 2, wherein the substrate comprises a scrim vinyl material and the map data is applied to the surface of the substrate in an ink composition that has been allowed to cure for a time that resists running when subjected to the normal weather conditions of the predetermined hunting region during hunting season.

4. A map structure as defined in claim 1, wherein the map includes the locations of water tanks and other points of interest to hunters within the predetermined hunting region.

5. A map structure as defined in claim 4, wherein the map includes (i) a GPS grid that provides a visual latitude and longitude grid that enables a hunter to conveniently locate the GPS coordinate data to key into a GPS receiver device, and (ii) GPS coordinate data in a predetermined coordinate system configured to enable a hunter to key in the GPS coordinate data directly from the map to a GPS receiver device in that coordinate system.

6. A map structure as defined in claim 1, wherein the substrate comprises a single substrate, and the map comprises the boundary of an entire predetermined hunting region.

7. A map structure as defined in claim 6, wherein the map includes topographical data for the hunting region within the boundary.

8. A map structure as defined in claim 7, wherein the topographical data is clipped to match the boundary, so that the boundary and the topographical material within the boundary are readily recognizable to a user of the map structure.

9. A map structure as set forth by claim 6, wherein the map includes land ownership data for the hunting region within the boundary.

10. A map structure as defined in claim 9, wherein the land ownership data is clipped to match the boundary, so that the boundary and the land ownership material within the boundary are readily recognizable to a user of the map structure.

11. A map structure as set forth by claim 6, wherein the map includes access data providing information about access to areas of the hunting region within the boundary.

12. A map structure as set forth by claim 11, wherein the access data also provides information outside the boundary about access to the hunting region within the boundary.

13. A method of forming a map structure for an outdoor region in which a special outdoor activity takes place, comprising the steps of
a. providing a substrate,
b. providing a data file with
i. data for use in producing a boundary of the outdoor region at a predetermined scale,
ii. data for producing a predetermined presentation of the outdoor region on the substrate, especially the outdoor region within the boundary, based on the predetermined scale,
iii. data for producing predetermined features of the outdoor region within the boundary, and
c. printing map data on the substrate, including printing the boundary of the outdoor region and the predetermined presentation of the outdoor region within the boundary, at the predetermined scale;
wherein the configuration of the substrate has been predetermined by the predetermined scale of the boundary of the outdoor region and the predetermined presentation of the outdoor region.

14. A method as set forth in claim 13, wherein the data file comprises an electronic data file that is stored on an electronic storage medium, and which can be selectively modified to reflect changes in the boundary of the outdoor region, or any material within the boundary of the outdoor region.

15. A method as set forth by claim 14, wherein the data file includes the boundary of the entire outdoor region, and wherein the step of printing map data on the substrate comprises printing the entire outdoor region and the boundary of the entire outdoor region on a single substrate.

16. A method as set forth by claim 15, wherein the data file includes topographical data for the outdoor region within the boundary, and the step of printing map data on the substrate comprises printing topographical data on the surface of the substrate.

17. A method as set forth by claim 16, wherein the topographical data is clipped to match the boundary, so the boundary and topographical data are readily recognizable when printed on the substrate.

18. A method as set forth by claim 17, wherein the outdoor region comprises a predetermined hunting region.

19. A method as set forth in claim 18, wherein the substrate comprises a material that is substantially resistant to physical deterioration under the normal weather conditions of the predetermined hunting region during hunting season, and substantially resistant to deterioration under normal use by a hunter in the predetermined hunting region.

20. A method as defined in claim 19, wherein the step of printing map data comprises printing map data on a surface of the substrate, in a medium that resists deterioration when subjected to the normal weather conditions of the predetermined hunting region during hunting season.

21. A method as defined in claim 19, wherein the substrate comprises a scrim vinyl material and the step of printing map data comprises printing map data on a surface of the substrate in an ink composition that is allowed to cure for a time that resists running when subjected to the normal weather conditions of the predetermined hunting region during hunting season.

22. A method as set forth by claim 15, wherein the data file includes land ownership data for the outdoor region within the boundary, and the step of printing map data comprises printing land ownership data on the surface of the substrate.

23. A method as set forth by claim 22, wherein the land ownership data is clipped to match the boundary, so the boundary and land ownership data are readily recognizable when printed on the substrate.

24. A method as set forth by claim 23, wherein the outdoor region comprises a predetermined hunting region.

25. A method as set forth in claim 24, wherein the substrate comprises a material that is substantially resistant to physical deterioration under the normal weather conditions of the predetermined hunting region during hunting season, and substantially resistant to deterioration under normal use by a hunter in the predetermined hunting region.

26. A map structure as defined in claim 25, wherein the step of printing map data comprises printing map data on a surface of the substrate, in a medium that resists deterioration when subjected to the normal weather conditions of the predetermined hunting region during hunting season.

27. A method as defined in claim 25, wherein the substrate comprises a scrim vinyl material and the step of printing map data comprises printing map data on a surface of the substrate in an ink composition that has been allowed to cure for a time that resists running when subjected to the normal weather conditions of the predetermined hunting region during hunting season.

28. A method as set forth in claim 15, wherein the data file includes
i. the geographic boundary of a hunting region, and
ii. the locations of water tanks within the geographic boundary; and
wherein the step of printing map data on the substrate comprises printing the locations of water tanks within the geographic boundary of the hunting region.

29. A method as set forth in claim 28, wherein the data file further includes
i. a GPS grid, and
ii. GPS coordinate data in a predetermined coordinate system that is configured to enable a hunter to key in the GPS coordinate data directly from the map to a GPS receiver device; and
wherein the step of printing map data on the substrate comprises printing the GPS grid and the GPS coordinate data on the substrate.

30. A method as set forth in claim 28, wherein the data file further includes
access data providing information about access to areas of the hunting region within the boundary, and information outside the boundary about access to the hunting region within the boundary, and
wherein the step of printing map data on the substrate comprises printing the access data on the substrate.
